(19) United States
(12) Patent Application Publication
(10) Pub. No.: US 2014/0002438 A1
(43) Pub. Date: Jan. 2, 2014

(54) SOURCE DRIVER AND LIQUID CRYSTAL DISPLAY DEVICE

(71) Applicant: LAPIS SEMICONDUCTOR CO., LTD., Yokohama (JP)

(72) Inventors: Masahiko HIGASHI, Yokohama (JP); Akira NAKAYAMA, Yokohama (JP)

(21) Appl. No.: 13/931,244

(22) Filed: Jun. 28, 2013

(30) Foreign Application Priority Data
Jun. 28, 2012 (JP) 2012-145511

(51) Int. Cl. G09G 3/36

(52) U.S. Cl. CPC G09G 3/3696
USPC 345/212; 345/87

(57) ABSTRACT

An improved source driver of a liquid crystal display device. Upon detection of discontinuation of the supply of internal logic power to a logic processing unit, an alternative signal of a predetermined potential is generated. This alternative signal is supplied to a liquid crystal panel in place of an LCD drive signal. The logic processing unit is a device for processing an input image signal.

### BACKGROUND OF THE INVENTION

1. Field of the Invention

The present invention relates to a source driver for driving a liquid crystal panel and a liquid crystal display device equipped with such source driver.

2. Description of the Related Art

Some countermeasures have been taken in liquid crystal display devices in order to prevent undesired (or unintentional) images and videos such as afterimages and irregularities from being displayed on a display panel (screen) of a liquid crystal display device when turning the liquid crystal display device off. Japanese Patent Application Publication (Kokai) No. 2011-170349, for example, discloses a method for preventing such unintentional display of undesired images and videos. This method discontinues the transmission of output signals to a liquid crystal panel via an output pad and establishes a discharge path extending from the output pad toward the ground (GND) when a decrease in voltage of a liquid crystal panel drive power (VDD 2) is detected.

### SUMMARY OF THE INVENTION

The technology disclosed in Japanese Patent Application Publication No. 2011-170349 has the following problems because it has to detect the decrease in voltage of the liquid crystal panel drive power (VDD 2). Specifically, as shown in FIG. 12A of Japanese Patent Application Publication No. 2011-170349, a large number of transistors for the VDD 2 are required in order to construct a circuit for detecting a decrease in voltage of the VDD 2. This results in an increase in the area required for the circuit. In addition, if a logic power is turned off prior to turning off of the VDD 2, drive control by an internal logic circuit is stopped prior to turning off of the VDD 2, and therefore afterimages are displayed on the liquid crystal panel for a long period.

An object of the present invention is to provide a source driver having a simple configuration and being able to prevent display of afterimages in a power OFF sequence.

Another object of the present invention is to provide a liquid crystal display device having such a source driver.

According to one aspect of the present invention, there is provided a source driver that includes a logic processing unit that is configured to receive internal logic power and generate a digital tone signal from an input image signal. The source drive also includes a panel drive unit that is configured to receive LCD drive power, convert the digital tone signal into an LCD drive signal, and supply the LCD drive signal to a liquid crystal panel. The penal drive unit includes a detector that is configured to detect discontinuation of the supply of the internal logic power to the logic processing unit and generate a detection signal. The panel drive unit also includes an alternative signal supply unit that is configured to generate an alternative signal of a predetermined potential in response to the detection signal and supply the alternative signal to the liquid crystal panel in place of the LCD drive signal.

The source driver can have a simple configuration to prevent afterimages from being displayed on the liquid crystal panel in a power OFF sequence.

According to another aspect of the present invention, there is provided a liquid crystal display device that includes a liquid crystal panel and a timing controller. The timing controller is configured to generate a drive command. The drive command contains a timing at which an LCD drive signal is to be supplied to the liquid crystal panel. The liquid crystal display device also includes a power unit that is configured to generate internal logic power and LCD drive power. The liquid crystal display device also includes a gate driver and a source driver that are configured to receive the internal logic power and the LCD drive power. Each of the gate driver and the source drive is configured to supply the LCD drive signal to the liquid crystal panel in response to the drive command. The source driver includes a logic processing unit that is configured to receive the internal logic power and generate a digital tone signal from an input image signal. The source driver also includes a panel drive unit that is configured to receive the LCD drive power, convert the digital tone signal into an LCD drive signal, and supply the LCD drive signal to the liquid crystal panel. The panel drive unit includes a detector that is configured to detect discontinuation of the supply of the internal logic power to the logic processing unit and generate a detection signal. The panel drive unit also includes an alternative signal supply unit that is configured to generate an alternative signal of a predetermined potential in response to the detection signal and supply the alternative signal to the liquid crystal panel in place of the LCD drive signal.

The liquid crystal display device can have a simple configuration to prevent afterimages from being displayed on the liquid crystal panel in a power OFF sequence.

These and other objects, aspects and advantages of the present invention will become apparent to those skilled in the art from the following detailed description when read and understood in conjunction with the accompanying drawings and claims.

### BRIEF DESCRIPTION OF THE DRAWINGS

FIG. 1 is a block diagram of a liquid crystal display device according to an embodiment of the present invention;

FIG. 2 is a block diagram of a source driver shown in FIG. 1;

FIG. 3 is a circuit diagram showing a configuration of a power-off detector shown in FIG. 2;

FIG. 4 is a circuit diagram showing a configuration of an alternative signal supply unit shown in FIG. 2;

FIG. 5A is a time chart showing when a power voltage and power-off detection signal are supplied to the source driver;

FIG. 5B is a time chart showing when an image signal is supplied from a timing controller of FIG. 1 to the source driver;

FIG. 5C is a time chart showing turning on and off of a backlight shown in FIG. 1; and

FIG. 6 is a circuit diagram showing a configuration of another power-off detector.

### DETAILED DESCRIPTION OF THE INVENTION

Embodiments according to the present invention are now described with reference to the accompanying drawings.

### First Embodiment

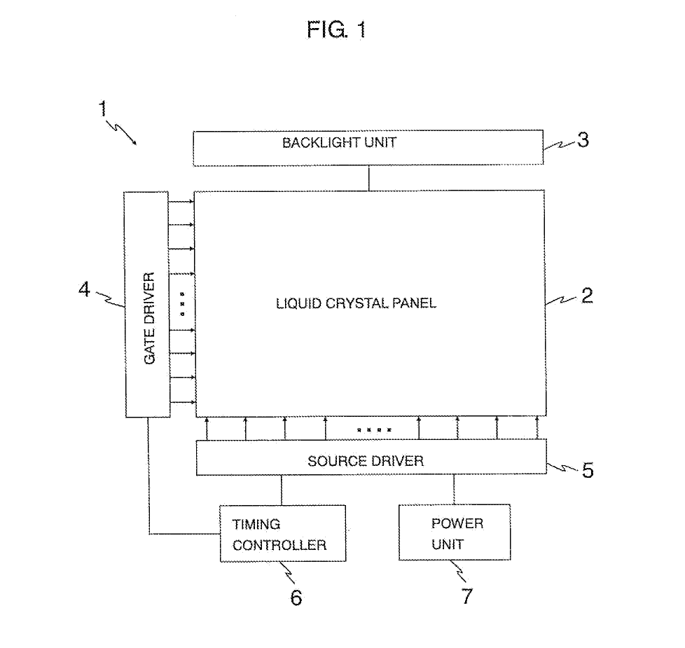

Referring to FIG. 1, a configuration of a liquid crystal display device 1 according to a first embodiment of the invention will be described.

A liquid crystal panel 2 is a display for displaying images and videos.

A backlight unit 3 illuminates the back of the liquid crystal panel 2 in order to display images and videos.

A gate driver 4 supplies the liquid crystal panel 2 with an LCD drive signal for sequentially activating a plurality of gate lines (not shown) of the liquid crystal panel 2 in response to a command sent from a timing controller 6.

In response to an image signal supplied from the timing controller 6, a source driver 5 supplies another LCD drive signal to the liquid crystal panel 2 via a plurality of source lines (not shown). This LCD drive signal is used for tone control.

The timing controller 6 issues LCD drive signal output commands to the gate driver 4 and the source driver 5 at appropriate timing, to control timing for displaying images and videos on the liquid crystal panel 2. The timing controller 6 also supplies the source driver 5 with image signals corresponding to the images and videos to be displayed on the liquid crystal panel 2.

A power unit 7 supplies power to components included in the liquid crystal display device 1. The power unit 7 supplies internal logic operation power (referred to as “logic power” or “logic power potential” hereinafter) and liquid crystal panel drive power (referred to as “LCD drive power” or “LCD drive power potential” hereinafter) to the source driver 5. Voltage VDDH of the LDC drive power is higher than voltage VDD of the logic power.

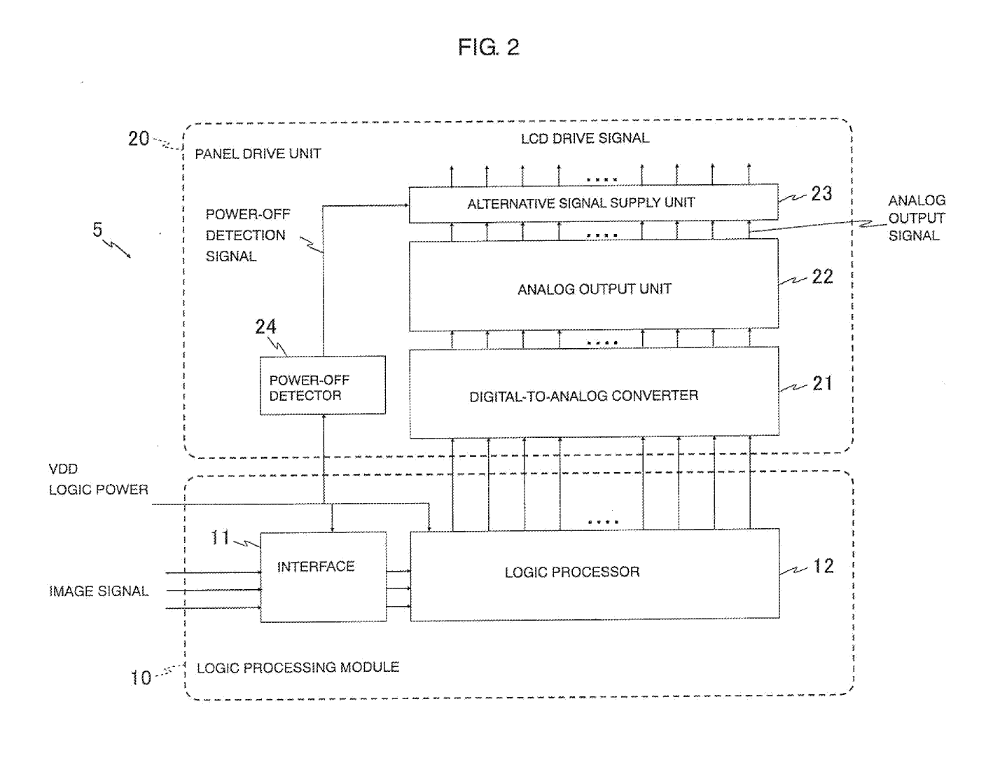

Referring to FIG. 2 a configuration of the source driver 5 will be described. The source driver 5 includes a logic processing unit 10 that is operated by supply of the logic power, and a panel drive unit 20 that is operated by supply of the LCD drive power.

The logic processing module 10 includes an interface 11 and a logic processor 12.

The interface 11 receives an image signal from the timing controller 6 (FIG. 1), converts the voltage thereof or performs other processes, and then sends the resultant image signal to the logic processor 12.

The logic processor 12 generates a digital tone signal based on the image signal sent from the interface 11. The digital tone signal contains a logical value corresponding to the tone of an image. The logic processor 12 then supplies the digital tone signal to a digital-to-analog converter 21.

The panel drive unit 20 includes the digital-to-analog converter 21, an analog output unit 22, an alternative signal supply unit 23, and a power-off detector 24.

The digital-to-analog converter 21 converts the digital tone signal, which is supplied by the logic processor 12, into an analog tone signal and supplies this analog tone signal to the analog output unit 22.

The analog output unit 22 amplifies the analog tone signal supplied from the digital-to-analog converter 21, and supplies the resulting LCD drive signal to the liquid crystal panel 2 (FIG. 1) via the alternative signal supply unit 23.

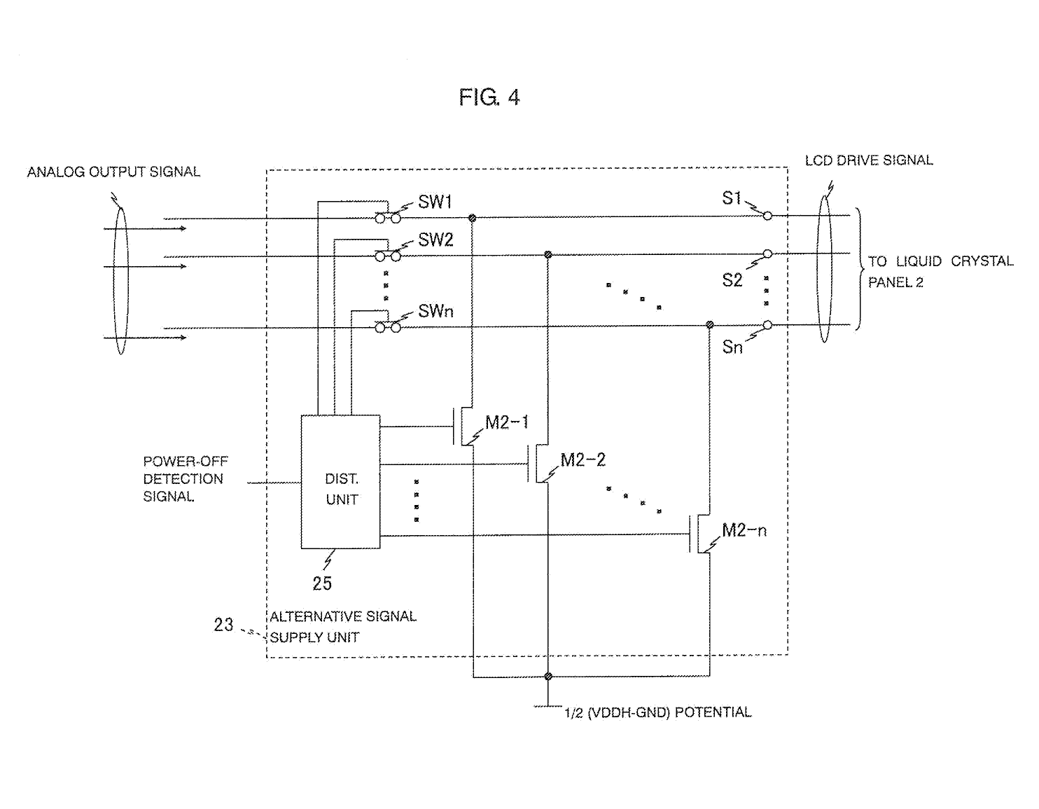

The alternative signal supply unit 23 sends the LCD drive signal, which is obtained from the analog output unit 22, to the liquid crystal panel 2 without any modification, when the alternative signal supply unit 23 is not supplied with a power-off detection signal from the power-off detector 24. When a power-off detection signal is supplied from the power-off detector 24, however, the alternative signal supply unit generates an alternative signal of a predetermined potential in response to the power-off detection signal, and supplies this alternative signal to the liquid crystal panel 2 (FIG. 1) in place of the LCD drive signal. An exemplary configuration of the alternative signal supply unit 23 will be described hereinafter (FIG. 4).

When the power-off detector 24 detects that the supply of the logic power from the power unit 7 to the source driver 5 is discontinued or that the logic power enters an OFF state, the power-off detector 24 generates a power-off detection signal and supplies it to the alternative signal supply unit 23.

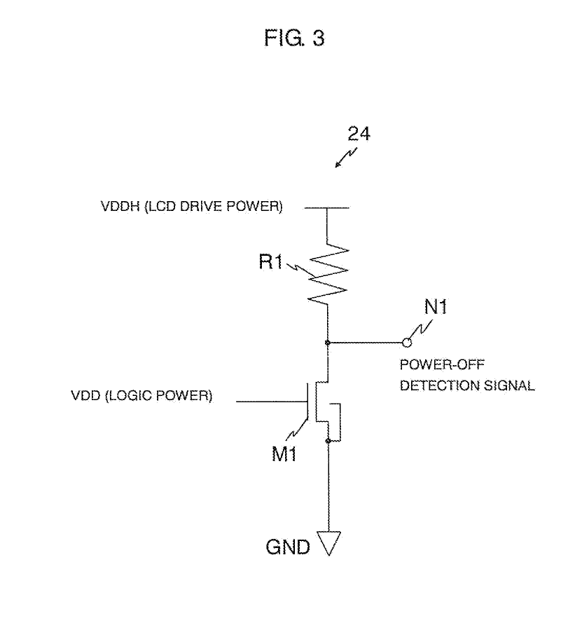

A configuration of the power-off detector 24 is now described with reference to FIG. 3.

The power-off detector 24 has a resistor R1 and an NMOS transistor M1. The NMOS transistor M1 is a field effect transistor. The resistor R1 has one end thereof connected to the LCD drive power and the other end to a drain of the NMOS transistor M1. The NMOS transistor M1 has the drain connected to an output terminal N1 of the power-off detection signal, a source and a sub (substrate) to a GND (ground potential), and a gate to the logic power. A resistance value of the resistor R1 is sufficiently greater than an on-resistance value of the NMOS transistor M1.

An exemplary configuration of the alternative signal supply unit 23 is described with reference to FIG. 4. Output pins S1 to Sn (n is an integer of 2 or more) of the source driver 5 (FIG. 1) are connected to the liquid crystal panel 2. An LCD drive signal may be supplied to the liquid crystal panel 2 from the output pins S1 through Sn. NMOS transistors M2-1 to M2-n, which are switching elements, are connected between the output pins S1 to Sn and a ½ (VDDH-GND). More specifically, the NMOS transistor M2-1 has a drain thereof connected to the output pin S1, and a source and a sub (substrate) to the GND. A power-off signal is introduced from the power-off detector 24 (FIG. 3) to a gate of the NMOS transistor M2-1. The NMOS transistors M2-2 to M2-n are connected in the same manner. The power-off signal is distributed to the gates of the NMOS transistors M2-1 to M2-n by a distribution unit 25. Switching elements SW1 to SWn are connected between an analog output signal and the LCD drive signal.

An ON-OFF operation of the liquid crystal display device 1 is now described with reference to FIGS. 1 to 5.

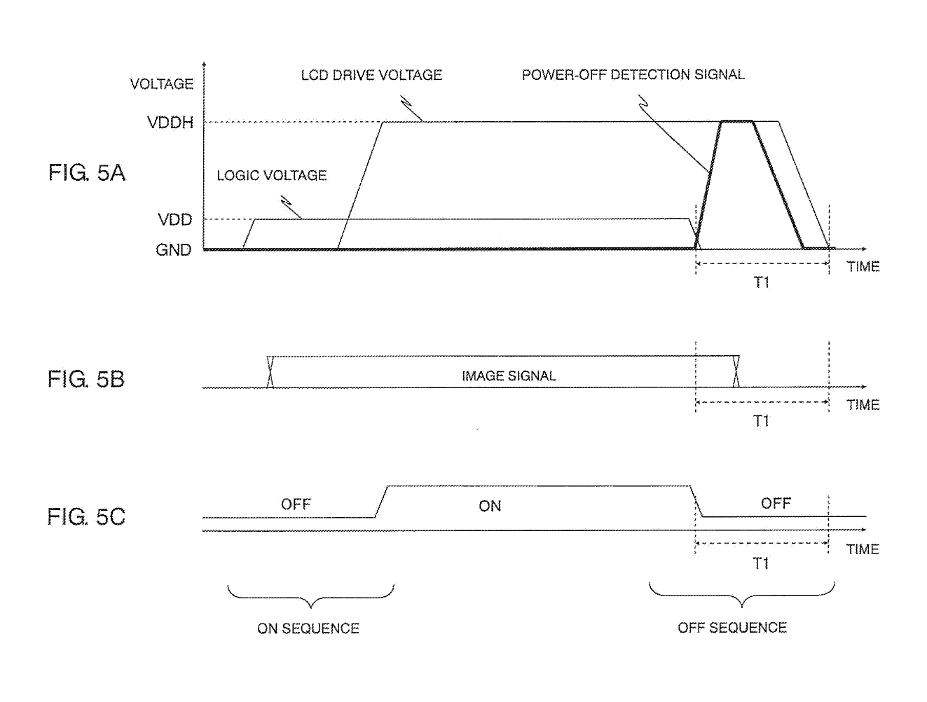

In an ON-sequence, first, a logic voltage is changed from GND to VDD, as shown in FIG. 5A. The NMOS transistor M1 is turned on as a VDD is supplied to the gate of the NMOS transistor M1. The voltage level of the power-off detection signal at this moment is equivalent to a value obtained by dividing the voltage between the VDD and the GND by the resistor R1 and the NMOS transistor M1. Because the resistance value of the resistor R1 is set to be sufficiently higher than the on-resistance value of the NMOS transistor M1, the voltage level of the power-off detection signal becomes substantially equal to the level of the GND. At this moment, a value that is substantially equivalent to the level of the GND is supplied to each of the gates of the transistors M2-1 to M2-n (FIG. 4) in the alternative signal supply unit 23 of the source driver 5. Each of the transistors M2-1 to M2-n enters an OFF state. When the voltage level of the power-off detection signal is substantially equal to the level of the GND, the switching elements SW1 to SWn enter an ON state, and the analog output signal and the LCD drive signal are linked to each other. Because the analog output signal and the LCD drive signal are linked to each other, the analog output signal from the analog output unit 22 itself is supplied to the liquid crystal panel 2 as an LCD drive signal.

As shown in FIG. 5A, after the logic voltage becomes VDD, the timing controller 6 starts supplying image signals to the source driver 5. Subsequently, the LCD drive voltage changes from GND to VDDH, as shown in FIG. 5B. Thereafter, the backlight of the backlight unit 3 enters an ON state, as shown in FIG. 5C. Then, an image or a video corresponding to the LCD drive signal supplied from the source driver 5 is displayed on the liquid crystal panel 2.

In an OFF sequence, first, the logic voltage changes from VDD to GND, as shown in FIG. 5A. A GND potential is introduced to the gate of the NMOS transistor M1, and therefore the NMOS transistor M1 is turned off. The voltage level of the power-off detection signal at this moment is pulled up to VDDH by the resistor R1. In the meantime, VDDH is supplied to each of the gates of the transistors M2-1 to M2-n (FIG. 4) in the alternative signal supply unit 23 of the source driver 5 and to each of the switching elements SW1 to SWn. Each of the transistors M2-1 to M2-n enters an ON state, and each of the switching elements SW1 to SWn enters an OFF state. The LCD drive signal has a ½ (VDDH-GND) potential. In other words, the liquid crystal panel 2 is not supplied with the analog output signal from the analog output unit 22 but with the ½ (VDDH-GND) potential.

As shown in FIGS. 5A and 5C, the backlight is turned off almost at the same time as when the logic voltage is changed to GND. On the other hand, as shown in FIG. 5A, drive control by the logic processor 12 is not carried out for a certain period of time (referred to as “time period T1” hereinafter) after the logic voltage is changed to GND. This keeps the LCD drive voltage at the VDDH level. Furthermore, as shown in FIG. 5B, the timing controller 6 continues to supply image signals to the source driver 5 during the time period T1. In this manner, although the LCD drive voltage is at the VDDH level and image signals are supplied to the source driver 5 during the time period T1, the alternative signal supply unit 23 fixes the potential output from the source driver 5, which is the potential input to the liquid crystal panel 2, at the ½ (VDDH-GND) potential in response to the power-off detection signal, even when a logic power voltage is GND. As a result, the liquid crystal panel 2 displays a black screen with no afterimages or irregularities.

As described above, the liquid crystal display device 1 of the first embodiment has the power-off detector 24 that is configured to detect the OFF state of the logic voltage. When the OFF state of the logic voltage is detected, a signal input to the liquid crystal panel 2 is set at a constant potential such as ½ (VDDH-GND) potential. According to this configuration, even when the LCD drive voltage is at the VDDH level and image signals are supplied to the source driver 5 for a certain period of time after the logic power is turned off in the OFF sequence, generation of afterimages or display-irregularities on the liquid crystal panel 2 can be prevented. In addition, in the first embodiment, power-off detection is executed using the power-off detector 24 which has the simple configuration shown in FIG. 3. Therefore, the power-off detection can be accomplished without increasing the size and complexity of the device and/or costs.

In the above-described and illustrated embodiment the potential output of the source driver 5 is set at the ½ (VDDH-GND) potential; however, the present invention is not limited to such embodiment. For example, the output pins S1 to Sn of the source driver 5 may be shorted to each other, and then the output potential of the source driver 5 may be fixed at the average of the potentials of the pins S1 to Sn, to allow the liquid crystal panel 2 to display a monochromatic image. In the first embodiment the potentials of the output pins S1 to Sn are fixed using the transistors M2-1 to M2-n; however, the potentials may be fixed using different elements and components.

### Second Embodiment

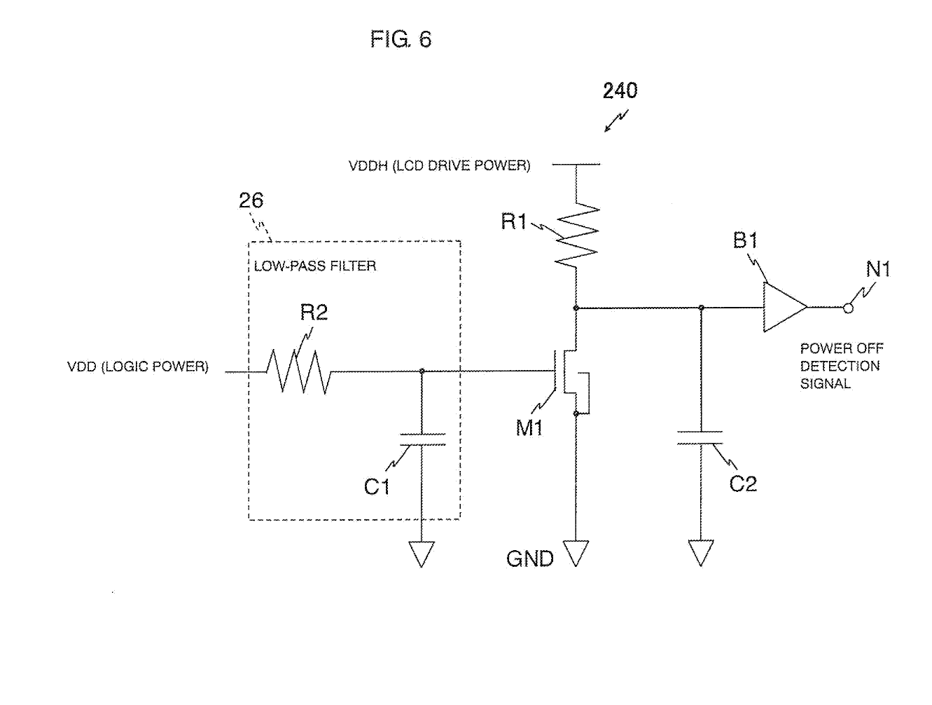

A second embodiment of the present invention will be described with reference to FIG. 6. Similar reference numerals are used to designate similar elements in the first and second embodiments. The second embodiment is different from the first embodiment in terms of the configuration of the power-off detector. The other configurations are same as those described in the first embodiment.

FIG. 6 shows a configuration of the power-off detector 240 according to the second embodiment. The power-off detector 240 includes the resistor R1 and the NMOS transistor M1. The resistor R1 has one end thereof connected to the VDDH and the other end to the drain of the NMOS transistor M1. The NMOS transistor M1 has the drain thereof connected to an input of a buffer B1, the source and sub (substrate) to the GND, and the gate to a VDD power via a resistor R2. A capacitor C1 is connected between the gate of the NMOS transistor M1 and the GND. The resistor R2 and the capacitor C1 constitute in combination a low-pass filter 26. The buffer B1 is provided for shaping the waveform of the power-off detection signal. A capacitor C2 is connected between the input of the buffer B1 and the GND for the purpose of noise removal. The buffer B1 supplies the power-off detection signal via the output terminal N1. The resistor R1 has a resistance value sufficiently greater than the on-resistance value of the NMOS transistor M1.

The ON-OFF operation of the liquid crystal display device 1 is same as the one described in the first embodiment. According to the liquid crystal display device 1 of the second embodiment, false detection operations can be prevented by using the low-pass filter 26 because the low-pass filter 26 eliminates (or removes) high-frequency noise that is generated in the logic power VDD at the time of turning the backlight on and off. Noise that is generated in the LCD drive power VDDH can also be removed by using the capacitor C2. The waveform of the power-off detection signal is shaped by the buffer B1 and the power-off detection signal is then supplied to the alternative signal supply unit 23. Consequently, the power-off detection operation of the liquid crystal display device 1 can stably be carried out.

This application is based on Japanese Patent Application No. 2012-145511 filed on Jun. 28, 2012, and the entire disclosure thereof is incorporated herein by reference.

What is claimed is:

1. A source driver comprising:
a logic processing unit configured to receive internal logic power and generate a digital tone signal from an input image signal; and
a panel drive unit configured to receive LCD drive power, convert the digital tone signal into an LCD drive signal, and supply the LCD drive signal to a liquid crystal panel, the penal drive unit including:
a detector configured to detect discontinuation of supply of the internal logic power to the logic processing unit and generate a detection signal; and
an alternative signal supply unit configured to generate an alternative signal of a predetermined potential in response to the detection signal and to supply the alternative signal to the liquid crystal panel in place of the LCD drive signal.

2. The source driver according to claim 1, wherein the detector includes:
an output terminal;
a resistor having one end thereof connected to the LCD drive power and the other end to the output terminal; and
a field effect transistor having a drain thereof connected to the other end of the resistor, a source connected to a ground potential, and a gate receiving the internal logic power, and wherein the detector takes a signal generated at the output terminal as the detection signal.

3. The source driver according to claim 2, wherein the detector further includes a low-pass filter, and the internal logic power is introduced to the gate of the field effect transistor via the low-pass filter.

4. The source driver according to claim 2 further comprising a capacitor connecting the output terminal of the detector to the ground potential.

5. The source driver according to claim 2, wherein the detection signal is obtained by buffering the signal generated at the output terminal of the detector.

6. The source driver according to claim 1, wherein the alternative signal supply unit includes:
a plurality of output pins; and
a plurality of second field effect transistors each having a drain thereof connected to one corresponding output pin out of the plurality of output pins, a source connected to the predetermined potential, and a gate receiving the detection signal,
and wherein when one of the second field effect transistors is turned on in response to the detection signal received at the gate of said one of the second field effect transistors, the alternative signal supply unit takes a signal generated at the output pin of said one of the second field effect transistors, as the alternative signal.

7. The source driver according to claim 6, wherein the predetermined potential is a potential of the LCD drive power, a ground potential, a potential between the potential of the LCD drive power and the ground potential, or an average of respective potentials of the plurality of output pins.

8. The source driver according to claim 1, wherein the predetermined potential is an average of the LCD driver power potential and a ground potential.

9. The source driver according to claim 1, wherein the LCD driver power potential is higher than the internal logic power potential.

10. The source driver according to claim 1, wherein the alternate signal supply unit supplies the alternative signal to the liquid crystal panel during a predetermined period.

11. A liquid crystal display device comprising:
a liquid crystal panel;
a timing controller configured to generate a drive command, said drive command containing a timing at which an LCD drive signal is to be supplied to the liquid crystal panel;
a power unit configured to generate internal logic power and LCD drive power; and
a gate driver and a source driver configured to receive the internal logic power and the LCD drive power, each of said gate driver and said source driver being configured to supply the LCD drive signal to the liquid crystal panel in response to the drive command,
the source driver including:
a logic processing unit configured to receive the internal logic power and generate a digital tone signal from an input image signal; and
a panel drive unit configured to receive the LCD drive power, convert the digital tone signal into an LCD drive signal, and supply the LCD drive signal to the liquid crystal panel,
the panel drive unit having:
a detector configured to detect discontinuation of supply of the internal logic power to the logic processing unit and generate a detection signal; and
an alternative signal supply unit configured to generate an alternative signal of a predetermined potential in response to the detection signal and supply the alternative signal to the liquid crystal panel in place of the LCD drive signal.

12. The liquid crystal display device according to claim 11, wherein the detector includes:
an output terminal;
a resistor having one end thereof connected to the LCD drive power and the other end to the output terminal; and
a field effect transistor having a drain thereof connected to the other end of the resistor, a source connected to a ground potential, and a gate receiving the internal logic power, and wherein the detector takes a signal generated at the output terminal as the detection signal.

13. The liquid crystal display device according to claim 12, wherein the detector further includes a low-pass filter, and the internal logic power is introduced to the gate of the field effect transistor via the low-pass filter.

14. The liquid crystal display device according to claim 12 further comprising a capacitor connecting the output terminal of the detector to the ground potential.

15. The liquid crystal display device according to claim 12, wherein the detection signal is obtained by buffering the signal generated at the output terminal of the detector.

16. The liquid crystal display device according to claim 11, wherein the alternative signal supply unit includes:
a plurality of output pins; and
a plurality of second field effect transistors each having a drain thereof connected to one corresponding output pin out of the plurality of output pins, a source connected to the predetermined potential, and a gate receiving the detection signal, and
wherein when one of the second field effect transistors is turned on in response to the detection signal received at the gate of said one of the second field effect transistors, the alternative signal supply unit takes a signal generated at the output pin of said one of the second field effect transistors, as the alternative signal.

17. The liquid crystal display device according to claim 16, wherein the predetermined potential is a potential of the LCD drive power, a ground potential, a potential between the potential of the LCD drive power and the ground potential, or an average of respective potentials of the plurality of output pins.

18. The liquid crystal display device according to claim 11, wherein the predetermined potential is an average of the LCD driver power potential and a ground potential.

19. The liquid crystal display device according to claim 11, wherein the LCD driver power potential is higher than the internal logic power potential.

20. The liquid crystal display device according to claim 11, wherein the alternate signal supply unit supplies the alternative signal to the liquid crystal panel during a predetermined period.
